(19) United States
(12) Patent Application Publication
(10) Pub. No.: US 2003/0067655 A1
(43) Pub. Date: Apr. 10, 2003

(54) Methods and systems for integrated IP routers and long haul/ultra long haul optical communication transceivers

(76) Inventors: Bo Pedersen, Annapolis, MD (US); Lee Daniel Feinberg, Silver Spring, MD (US); Guangning Yang, Clarksville, MD (US); Brent Ashley Miller, Baltimore, MD (US); William C. Phillips, Ellicott City, MD (US)

Correspondence Address: HARRITY & SNYDER, LLP, 11240 WAPLES MILL ROAD, SUITE 300, FAIRFAX, VA, 22030, US

(21) Appl. No.: 09/971,075

(22) Filed: Oct. 5, 2001

(51) Int. Cl. H04J 14/08; H04B 10/00

(52) U.S. Cl. 359/152; 359/139

(57) ABSTRACT

An IP router is integrated with an LRTR. A forward error correction (FEC) unit associated with the LRTR provides a frame structure, error detection and other functionality previously performed by SDH or SONET protocol devices. The FEC unit is clocked independently of the routing functionality and a processor coordinates the flow of IP data packets between the routing functionality and the LRTR functionality, e.g., by controlling buffer underflow and overflow conditions.

### FIELD OF INVENTION

This invention relates generally to optical communication networks and, more particularly, to methods and systems for integrating internet protocol (IP) routers with optical communication transceivers.

### BACKGROUND OF THE INVENTION

From the advent of the telephone, people and businesses have craved communication technology and its ability to transport information in various formats, e.g., voice, image, etc., over long distances. Typical of innovations in communication technology, recent developments have provided enhanced communications capabilities in terms of the speed at which data can be transferred, as well as the overall amount of data being transferred. As these capabilities improve, new content delivery vehicles, e.g., the Internet, wireless telephony, etc., drive the provision of new services, e.g., purchasing items remotely over the Internet, receiving stock quotes using wireless short messaging service (SMS) capabilities etc., which in turn fuels demand for additional communications capabilities and innovation.

Recently, optical communications have come to the forefront as a next generation communication technology. Advances in optical fibers over which optical data signals can be transmitted, as well as techniques for efficiently using the bandwidth available on such fibers, such as wavelength division multiplexing (WDM), have resulted in optical technologies being the technology of choice for state-of-the-art long haul communication systems.

Depending upon the relative locations of the data source and the intended recipient, optical data signals may traverse different optical communication systems in their path between the two locations, e.g., for trans-Atlantic data connections. For example, optical signals may traverse both a terrestrial optical communication system and a submarine optical communication system. As shown in FIG. 1, a terrestrial signal is processed in a WDM terminal 12 of a submarine optical communication system 10 for transmission via optical fiber 14. For long haul optical communications, e.g., greater than one hundred kilometers, the optical signal is periodically amplified to compensate for the tendency of the data signal to attenuate. Therefore, in the submarine system 10, line units 16 amplify the transmitted signal so that it arrives at WDM terminal 18 with sufficient signal strength (and quality) to be successfully transformed back into a terrestrial signal.

Conventionally, erbium-doped fiber amplifiers (EDFAs) have been used for amplification in the line units 16 of such systems. As seen in FIG. 2(a), an EDFA employs a length of erbium-doped fiber 20 inserted between the spans of conventional fiber 22. A pump laser 24 injects a pumping signal having a wavelength of, for example, approximately 1480 nm into the erbium-doped fiber 20 via a coupler 26. This pumping signal interacts with the f-shell of the erbium atoms to stimulate energy emissions that amplify the incoming optical data signal, which has a wavelength of, for example, about 1550 nm. One drawback of EDFA amplification techniques is the relatively narrow bandwidth within which this form of resonant amplification occurs, i.e., the so-called erbium spectrum. Future generation systems will likely require wider bandwidths than that available from EDFA amplification in order to increase the number of channels (wavelengths) available on each fiber, thereby increasing system capacity.

Distributed Raman amplification is one amplification scheme that can provide a broad and relatively flat gain profile over a wider wavelength range than that which has conventionally been used in optical communication systems employing EDFA amplification techniques. Raman amplifiers employ a phenomenon known as “stimulated Raman scattering” to amplify the transmitted optical signal. In stimulated Raman scattering, as shown in FIG. 2(b), radiation from a pump laser 24 interacts with a gain medium 22 through which the optical transmission signal passes to transfer power to that optical transmission signal. One of the benefits of Raman amplification is that the gain medium can be the optical fiber 22 itself, i.e., doping of the gain material with a rare-earth element is not required as in EDFA techniques. The wavelength of the pump laser 24 is selected such that the vibration energy generated by the pump laser beam's interaction with the gain medium 22 is transferred to the transmitted optical signal in a particular wavelength range, which range establishes the gain profile of the pump laser.

In addition to amplification, optical communication systems, both terrestrial and submarine, typically employ standardized multiplexing schemes for transporting optical data signals, i.e., according to Synchronous Digital Hierarchy (SDH) or Synchronous Optical Network (SONET). These standardized multiplexing schemes govern interface parameters such as optical transmission rates, formats, multiplexing methods and other transmission parameters. Today, most international submarine systems employ SDH transport mechanisms, whereas North American terrestrial systems employ SONET transport mechanisms. Among other things, this means that interfaces are needed between the terrestrial and submarine optical communication systems in order to deliver data therebetween.

Another complicating factor in the evolution of global optical communication systems is the rapidly rising popularity of the Internet. In some communication networks, the amount of internet data traffic exceeds that of other traffic, e.g., voice traffic. Since internet data traffic employs the Internet Protocol (IP) as its transport mechanism, system designers need to address the issues associated with transmitting IP data streams over SDH/SONET optical communication systems.

One approach to this problem has been to pack IP data packets into SDH/SONET frames. An example of this approach is described in U.S. Pat. No. 6,236,660, entitled “Method for Transmitting Data Packets and Network Element for Carrying Out the Method”, the disclosure of which is incorporated herein. According to this patent, data packets are packed into synchronous transport modules and are transmitted by way of virtual connections formed by subunits of synchronous transport modules of the same size. The virtual connections are entered into an address table. Using the address table and a target address for a new data packet, a virtual connection is selected for use in transmitting the new data packet. However, even advanced techniques for packing IP data packets into SDH/SONET frames do not resolve the fundamental expense associated with adding SDH/SONET equipment to the communication system chain.

For example, many types of end-user equipment, e.g., IP routers and asynchronous transfer mode (ATM) switches, are now being designed with interfaces for SDH and/or SONET. Thus for example, as illustrated in FIG. 3, an IP router 30 is provided with a short reach transceiver 32 (SRTR) and SDH/SONET interface processing equipment 34 to forward selected IP data packets (via routing function 35) to a long reach transceiver 36 (LRTR), e.g., included in terminal 12 in FIG. 1, which also includes SRTR 32 and, optionally, SDH/SONET or other interface processing equipment 38. These SONET/SDH interfaces and SRTR transceivers, however, add significantly to the cost of the router 30 and terminal 12.

Accordingly, it would be desirable to provide an integrated IP router/LRTR that avoids the expense and complexity associated with conventional solutions for routing IP data packets over SONET to terminals for long haul communications.

### BRIEF SUMMARY OF THE INVENTION

These, and other, drawbacks, limitations and problems associated with conventional optical communication systems are overcome by exemplary embodiments of the present invention, wherein an IP router is integrated with an LRTR. A forward error correction (FEC) unit associated with the LRTR provides a frame structure, error detection and other functionality previously performed by SDH or SONET protocol devices. The FEC unit is clocked independently of the routing functionality and a processor coordinates the flow of IP data packets between the routing functionality and the LRTR functionality, e.g., by controlling buffer underflow and overflow conditions.

According to one exemplary embodiment, an integrated IP router and LRTR include: a router switch buffer for receiving incoming IP data packets from a first transceiver; a router switch for receiving the IP data packets from the router switch buffer and forwarding the IP data packets to a transmit buffer; a processor for controlling output of the IP data packets in a data stream from the transmit buffer into a long reach transmit processing branch of a second transceiver, wherein the long reach transmit processing branch includes: a forward error correction (FEC) unit for adding error correction to the data stream to generate a composite data stream; and a modulator for optically modulating said composite data stream onto a wavelength channel.

According to another exemplary embodiment of the present invention, an integrated IP router and LRTR includes: a long reach receive processing branch of a first transceiver for receiving a composite, optical data stream on a wavelength channel including: a demodulator for optically demodulating the composite, optical data stream; and a forward error correction (FEC) unit for removing error correction data from said demodulated, composite, optical data stream to generate a decoded data stream; an incoming packet processor for receiving the decoded data stream, extracting IP data packets therefrom and forwarding the IP data packets to a router switch buffer based on routing information; and a router switch for receiving the IP data packets from the router switch buffer and forwarding the IP data packets to a transmit buffer for transmission via a second transceiver.

### BRIEF DESCRIPTION OF THE DRAWINGS

FIG. 1 is a schematic diagram of an optical communication system in which the present invention can be implemented;

FIG. 2(a) is a conceptual diagram of a conventional erbium-doped fiber amplifier;

FIG. 2(b) is a conceptual diagram of a conventional Raman amplifier;

FIG. 3 is a block diagram of a conventional IP router connected to a conventional LRTR terminal via a fiber optic link;

FIG. 4 is a block diagram of a conventional router with a short reach transceiver;

FIG. 5 is a block diagram of a transmit portion of an exemplary integrated IP router/LRTR according to an exemplary embodiment of the present invention;

FIG. 6 is a block diagram of a receive portion of an exemplary integrated IP router/LRTR according to an exemplary embodiment of the present invention;

FIG. 7 depicts an exemplary point-to-point network including integrated IP router/LRTRs according to an exemplary embodiment of the present invention;

FIG. 8 depicts an exemplary ring network including integrated IP router/LRTRs according to an exemplary embodiment of the present invention;

FIGS. 9-11 illustrate connectivity between integrated IP router/LRTRs and WDM equipment according to different exemplary embodiments of the present invention; and

FIG. 12 shows a hybrid router architecture according to an exemplary embodiment of the present invention.

### DETAILED DESCRIPTION

In the following description, for the purposes of explanation and not limitation, specific details are set forth, such as particular systems, networks, software, components, techniques, etc., in order to provide a thorough understanding of the present invention. However, it will be apparent to one skilled in the art that the present invention may be practiced in other embodiments that depart from these specific details. In other instances, detailed descriptions of known methods, devices and circuits are abbreviated or omitted so as not to obscure the present invention.

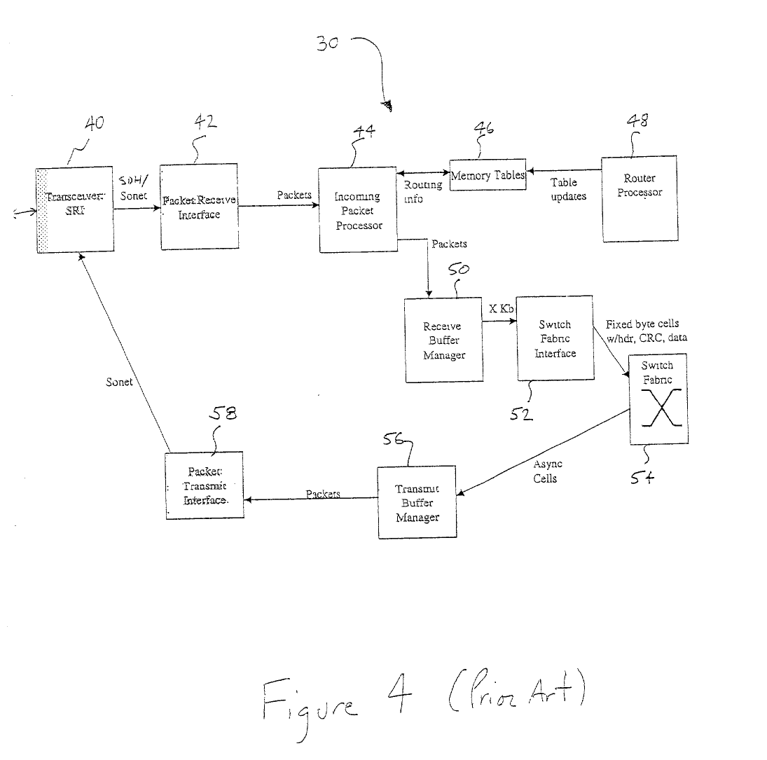

To provide a better understanding of the present invention, a block diagram of a conventional IP router 30 will first be described is provided in FIG. 4. Therein, a transceiver 40 having a short reach interface receives optical data in SDH or SONET frames in a conventional manner, e.g., using a photosensor and demodulator. Transceiver 40 also includes conventional transmit circuitry, e.g., a modulator and laser. The SDH/SONET framed data is passed to packet receive interface 42 that performs the recovery of the physical layer data packaged into the SDH/SONET frames. Thus, packet receive interface 42 performs, among other functions, clock and data recovery, recovery of SDH/SONET overhead information, alarm processing, detection/discarding of corrupted packets, and extracts the IP data packets from the SDH/SONET frames. IP data packets are forwarded to an incoming packet processor 44. Incoming packet processor 44 reads the data packet headers for validation and routing purposes. The incoming packet processor 44 uses information from each data packet header to match a destination of the data packet with an output port of the router 30. This is accomplished by mapping the destination information in the data packet header with port information in memory tables 46, e.g., using an output port table stored in memory tables 46 as well as pointers to those ports which inform the incoming packet processor 44 where, within the router 30, the specific ports are located. Since the configuration and allocation of the router ports will vary over time, router processor 48 will periodically update the table information stored in memory tables 46.

Once the incoming packet processor 44 has acquired the routing information for a particular data packet, it forwards that packet along with the routing information to a receive buffer manager 50. The receive buffer manager 50 breaks the packets up into smaller chunks of a predetermined size, e.g., 64 Kb, which chunks are referred to herein as “cells”. Each cell can include a header, a data portion and a cyclic redundancy check (CRC) field. This operation is performed so that the non-uniform size IP data packets are transformed into fixed length units that the switch fabric 54 is designed to process. The receive buffer manager 50 also may include a number of different queues which provide different qualities of service (QoS), i.e., by reducing the delay associated with routing data packets which have a high QoS associated therewith. The cells are then forwarded to a switch fabric interface 52 which is responsible for scheduling access to the line cards (not shown) associated with the input ports on the switch fabric 54. As scheduling permits, the switch fabric interface 52 individually transmits the cells to the switch fabric 54 where they are output on the predetermined output port to transmit buffer manager 56. As indicated in FIG. 4, the transmission of cells from the switch fabric 54 to the transmit buffer manager 56 is asynchronous, which feature of conventional routers has significant implications for integration according to the present invention as will be described in more detail below.

The transmit buffer manager 56 reassembles the cells into their respective IP data packets. Once reassembled, they are then forwarded to the packet transmit interface 58, which stuffs them back into SDH or SONET frames. The SDH/SONET frames are then forwarded to transceiver 40 for transmission over an appropriate link based on the packet's destination. Those skilled in the art will appreciate that the foregoing discussion of router functionality is intended to be general in nature, at a level sufficient to convey an understanding of the integrated routers/LRTRs described below. However, readers interested in additional detail regarding exemplary router implementations are referred to U.S. Pat. Nos. 5,463,777, 5,509,006 and 5,740,171, the disclosures of which are incorporated here by reference.

As mentioned above, the use of SDH/SONET and, more particularly, the need to incorporate a packet receive interface 42, a packet transmit interface 58 and a short reach transceiver 40 into router 30 adds significantly to the expense of the router and the system of which the router 30 is but one component. Additionally, the use of SDH/SONET creates overhead of about 15% that results in an inefficient use of the available bandwidth. Moreover, IP networks typically employ mesh architectures, whereas SDH/SONET protocols were developed to enhance ring architectures. Thus, some of the benefits associated with using the SDH/SONET protocols are often wasted in IP network implementations.

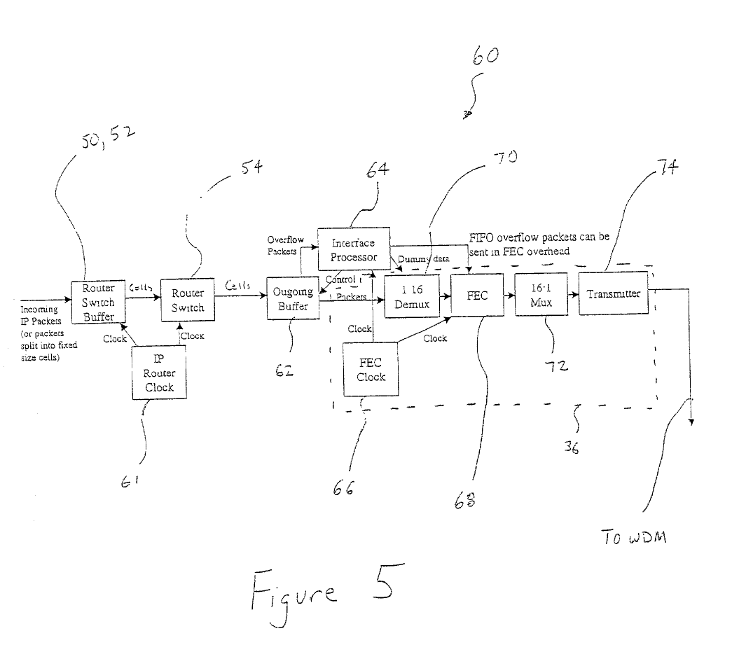

According to exemplary embodiments of the present invention, at least units 40, 42 and 58 can be omitted from router 30 when a long reach transceiver is integrated into the router 30. An exemplary integrated IP router/LRTR according to an embodiment of the present invention is shown in FIG. 5. Therein, as in the conventional router 30, IP packets are sent to the router switch buffer 50, 52 and provided as cells to the router switch 54. Both the router switch buffer 50, 52 and the router switch 54 are clocked by an IP router clock 61.

At this point, the LRTR 36 is integrated into the IP router 30. At least two interfaces can be provided. First, the LRTR 36 can be integrated into the IP router 30 immediately after the switch fabric 54, in which case the data input to the LRTR 36 would comprise cells. Alternatively, the LRTR 36 can be integrated into the IP router 30 downstream of the transmit buffer manager 56, in which case the data input to the LRTR would be IP packets. In either case, the integration of the IP router 30 and LRTR 36 is substantially similar with the exception that in the alternative wherein cells are transmitted across the long haul or ultra long haul link, they will be reassembled into IP packets at the receive side. In this example, packet transmission is described, i.e., outgoing buffer 62 will reassemble the cells into packets before passing the packets onto the LRTR 36.

In any event, outgoing buffer 62, in conjunction with interface processor 64, controls the provision of the IP data packets (or cells), to the LRTR 36. If the outgoing buffer 62 receives cells, then those cells are reassembled into their respective IP data packets by the outgoing buffer 62. If the outgoing buffer 62 receives IP data packets, then outgoing buffer 62 can, for example, include a first-in first-out (FIFO) buffer which accepts IP data packets as clocked in by the IP router clock 61 and outputs IP data packets to the LRTR 36 as clocked out by the forward error correction (FEC) clock 66. More specifically, as mentioned above, the output of the IP router switch 54 will be asynchronous given the inherent nature of the switching fabric in transferring data cells between its input ports and output ports for any given stream of IP data packets. LRTR 36, on the other hand, includes an FEC unit 68 that requires input streams to be synchronous at its predetermined clock rate. Thus, interface processor 64 is also clocked at the FEC clock rate so that it can read IP data packets out from the outgoing buffer 62 at the proper rate.

The FEC unit 68 is, in this example, preceded by a demultiplexer 70 and followed by a multiplexer 72. The demultiplexer 70 is provided in the transmit processing chain of the LRTR 36 in order to divide the stream of incoming IP data packets into a number of slower, parallel data streams that each have a rate that is commensurate with the internal processing speed of the FEC unit 68. For example, consider that, purely for purposes of illustration, the router switch 54 provides IP data packets at a rate which is substantially equal to 10 Gbps (e.g., an OC-192 rate per SONET terminology) and that the long haul or ultra long haul transmitter 36 transmits optical signal data at approximately 10 Gbps, i.e., plus the redundancy added by FEC unit 68 and any additional signaling overhead. Moreover, suppose that the FEC unit 68 has an internal processing speed such that it accepts input streams of 622 Mbps. Then, the demultiplexer 70 divides the incoming data stream from the outgoing buffer 62 into 16 streams of 622 Mbps data for input to the FEC unit 68. Once the error correction code has been added, e.g., a block code or a convolutional code, the IP data packets are inserted into the payload portion of respective FEC frames and the data streams are then multiplexed back together into a substantially OC192 data stream (plus FEC redundancy) by multiplexer (MUX) 72.

Of course, since the output from the router switch 54 is asynchronous, there may be occasions when the outgoing buffer 62 experiences underflow or overflow conditions. Overflow packets are removed from the outgoing buffer 62 by the interface processor 64 and inserted into the available FEC overhead fields. The interface processor 64 can mark the insertion of overflow packets into the FEC overhead data stream using a flag or a code having a predetermined value that precedes the data packet in the FEC overhead data stream. When an underflow condition is detected by interface processor 64, it inserts dummy data into the data stream at the FEC clock rate. Again, the interface processor 64 can mark the insertion of dummy data into the data stream by inserting a flag or code having a predetermined value before (and if the dummy data is variably sized after) the dummy data.

After conversion from the electrical domain back into the optical domain, the data signal is then modulated by transmitter (TX) 74. In addition to its use of FEC 68, the LRTR 36 differs from the short reach transceiver 40 found in conventional routers in that the modulation employed will be selected for its long haul/ultra long haul transmission characteristics. For example, return-to-zero (RZ) or carrier suppressed return-to-zero (CSRZ) modulation can be used due to their robustness with respect to signal degradation associated with nonlinear transmission effects.

After modulation, or in conjunction therewith, a signal conditioning unit 76 further conditions the optical data signal for long distance transmission, which conditioning represents another difference between short reach transceivers and long reach transceivers. Over long haul and ultra long haul distances, e.g., greater than 100 km, non-determinant variances associated with the fiber in the transmission link and other phenomenon will significantly affect the transmission of optical data signals. These non-determinant variances are wavelength dependent and can be evaluated using system simulations. Signal conditioning unit 76 may, therefore, include preemphasis functionality which tailors the transmit power on each wavelength channel to precompensate for the effects that the optical data signal will experience during transmission. For example, the preemphasis can be set in each LRTR 36 so that each wavelength channel is received with minimal gain or signal-to-noise ratio (SNR) excursion relative to the other wavelength channels in the WDM composite signal. The preemphasis can be applied by way of a variable attenuator (not shown) or a filter placed in the optical signal path. Other types of signal conditioning, e.g., dispersion compensation and/or the addition of signal chirp (phase modulation), can also be performed by signal conditioning unit 76 to prepare the signal for long haul/ultra long haul transmission distances.

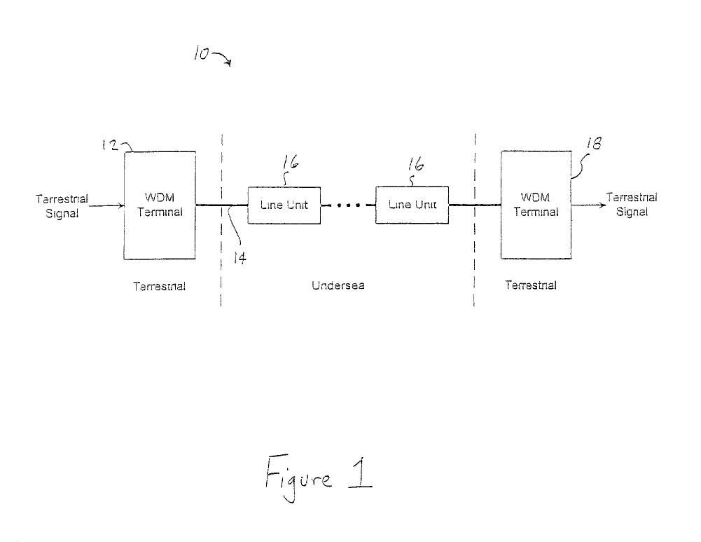

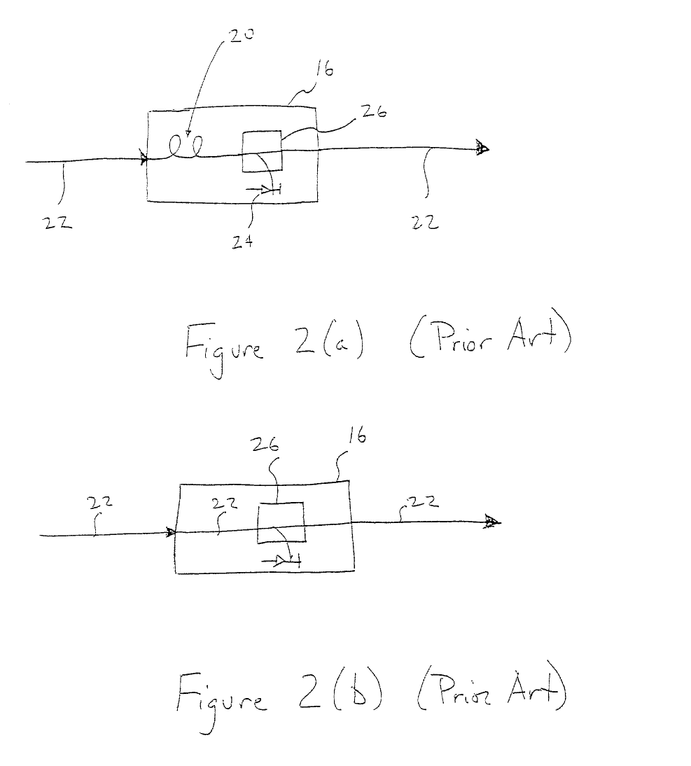

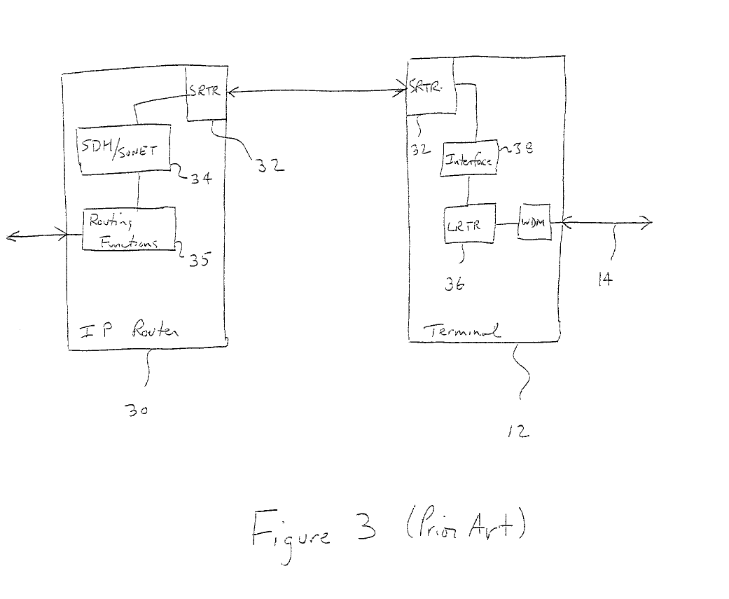

After signal conditioning, the wavelength channels associated with each of the OC192 data streams are combined by a wavelength multiplexer (not shown) to generate a WDM signal that is coupled to the optical fiber of the long haul or ultra long haul optical communication system, e.g., the submarine system of FIG. 1 or a terrestrial system. The WDM equipment can be disposed externally of the integrated router/LRTR 60, e.g., at a cable landing station.

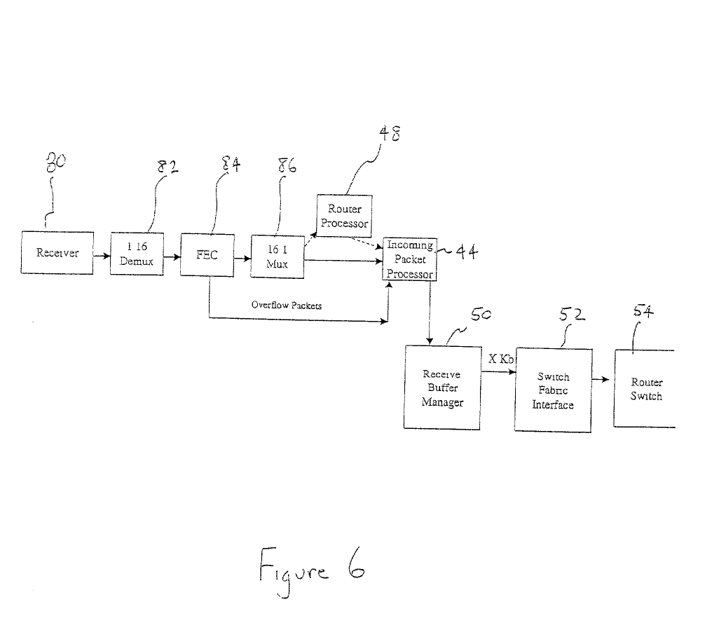

Although only a single transmit outgoing buffer 62 and LRTR 36 are depicted in FIG. 5, those skilled in the art will appreciate that any number of transmit chains can be employed in an integrated router/LRTR according to the present invention. Each integrated router/LRTR will have at least two transceivers, i.e., to support at least two input ports and two output ports, at least one of which will be a long haul or ultra long haul transceiver. Likewise, an integrated router/LRTR according to the present invention will have a number of receive processing chains, an example of which is provided as FIG. 6. Therein, receiver 80 provides O/E conversion, demodulation, etc. of an optical data signal received from a WDM demultiplexer (not shown). Again, the received signal is divided into a plurality of data streams at demultiplexer 82 prior to being fed into FEC unit 84 where transmission errors are corrected and the forward error correction coding is removed. FEC unit 84 also extracts any data packets that were transmitted in the FEC overhead stream, e.g., upon identifying the predetermined code or flag value that precedes such data packets, and provides that information to the incoming processor 44 so that those IP data packets can also be reconstructed. Likewise, dummy data is identified by its corresponding flag(s) or code(s) and discarded. The process of identifying and handling data packets which are stuffed into the FEC overhead stream and dummy data within the FEC payload stream can be performed by the FEC unit itself or can be performed by a separate logic unit (not shown), e.g., an FPGA. Multiplexer 86 recombines the outputs of the FEC unit 84 and passes the data to the incoming packet processor 44. If cells are transmitted to the integrated router/LRTR, then the router processor 48 will reassemble them into their respective IP data packets. The remaining blocks 50, 52 and 54 of the receive processing chain operate as described above.

As will be appreciated by the foregoing exemplary embodiments, integrated IP routers/LRTRs use the FEC units of the LRTRs to replace much of the functionality previously provided by the SDH or SONET protocol layers. For example, the FEC units provide a framing structure that replaces the framing structures previously provided by SDH or SONET. One example of an FEC framing structure which can be used by FEC units according to the present invention is that defined by ITU specification G.975 which FEC employs a Reed-Solomon block code and a frame structure which provides for 16 bytes of overhead, 3808 bytes of payload data and 256 bytes of redundancy in each frame. Those skilled in the art will appreciate that this is merely one example and that any type of forward error correction coding and FEC framing structure may be used in LRTRs which are integrated into routers according to the present invention. The FEC units 84 also provide a mechanism for error checking, which function was previously performed by the SDH or SONET functionality in conventional routers.

Integrated IP router/LRTR architectures according to the present invention provide many advantages over conventional, independent IP router and LRTR structures. Initially, the expensive SDH or SONET interfaces and at least two short reach transceivers (i.e., one in the router and one in the terminal) are eliminated, thus making solutions according to the present invention cost effective communication network components. Moreover, Applicants anticipate that the functionality described above for permitting the integrated IP router/LRTR to directly stuff FEC overhead with overflow IP data packets will also permit the integrated IP router/LRTR to add its own generalized multiprotocol label switching (GMPLS) commands to the IP data packet stream between edge devices. Those skilled in the art will appreciate that GMPLS commands, generally, provide for adaptive packet routing that can provide, among other functionalities, traffic engineering, class of service and virtual private networking. Readers interested in more detail regarding GMPLS commands are referred to the articles “Multiprotocol Label Switching: Enhancing Routing in the New Public Network” by Chuck Semairia, 2000, and “Generalized Multiprotocol Label Switching: An Overview of Routing and Management Enhancements”, by A. Banerjee et al., IEEE Communications Magazine, January 2001, pp. 144-150, the disclosures of which are incorporated here by reference.

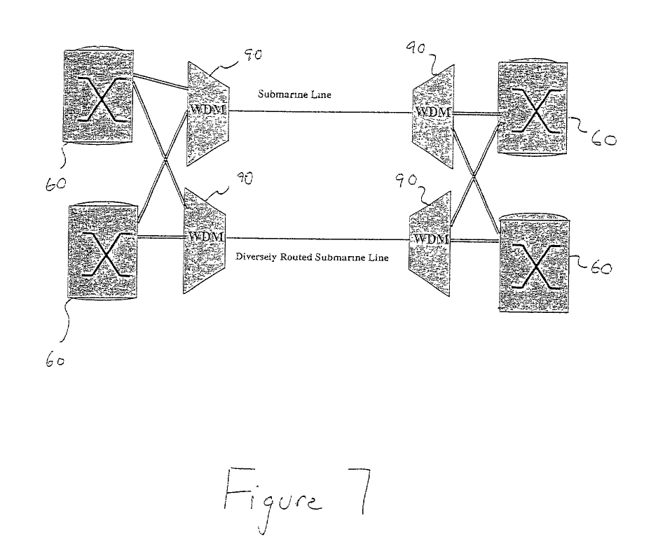

As mentioned above, the WDM equipment used to perform wave division multiplexing combination and separation can be provided externally of the integrated IP router/LRTRs according to the present invention. This leads to various network architectures. For example, FIG. 7 depicts a point-to-point architecture wherein integrated IP router/LRTRs share two diversely routed, submarine optical links. Two integrated IP router/LRTRs 60 are each coupled to WDM equipment 90 on either side of each link. Those skilled in the art will appreciate that this can be extended to N integrated IP routers/LRTRs 60 being connected to N sets of WDM equipment. This configuration enables optical signal data to be transmitted using a variety of protection schemes, e.g., 1+1 using the same wavelength and diverse path, 1/0 (unprotected) or M:N by assigning additional transceivers as backups. The present invention is amenable to any and all types of WDM equipment 90 for multiplexing optical data signals on individual wavelength channels, examples of which are provided in U.S. Pat. Nos. 6,211,978 and 5,712,936, the disclosures of which are incorporated here by reference.

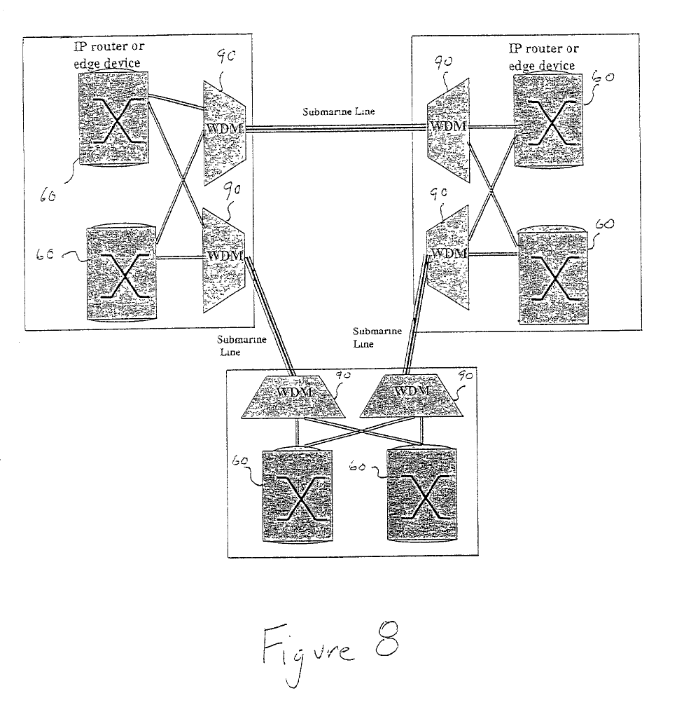

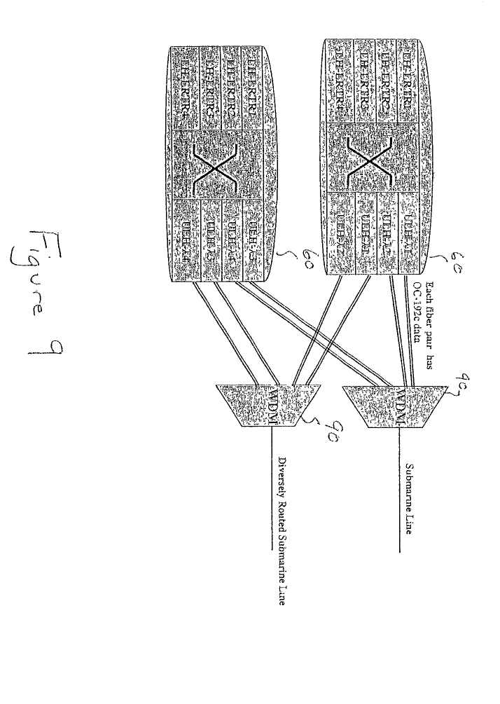

The present invention can also be implemented in ring architectures (FIG. 8) and mesh architectures (not shown). If each LRTR 36 in the integrated IP router/LRTR 60 has a fixed wavelength associated therewith, then the connection of individual transmit/receive processing branches to WDM equipment 90 should be arranged based on wavelengths. For example, as shown in FIG. 9, each integrated IP router/LRTR 60 may transmit over a subset of the available wavelengths, e.g., λ1 and λ2 for the uppermost integrated IP router/LRTR 60 and λ3 and λ4 for the lowermost unit 60. (Each integrated IP router/LRTR 60 in FIG. 9 is shown as having ultra long-haul (ULH) transceivers facing the submarine side of the network and long-haul (LH) transceivers toward the terrestrial side). Then, a complete subset from each unit 60 is connected with each WDM equipment 90 so that the WDM equipment 90 then receives optical data signals on each wavelength channel for combination.

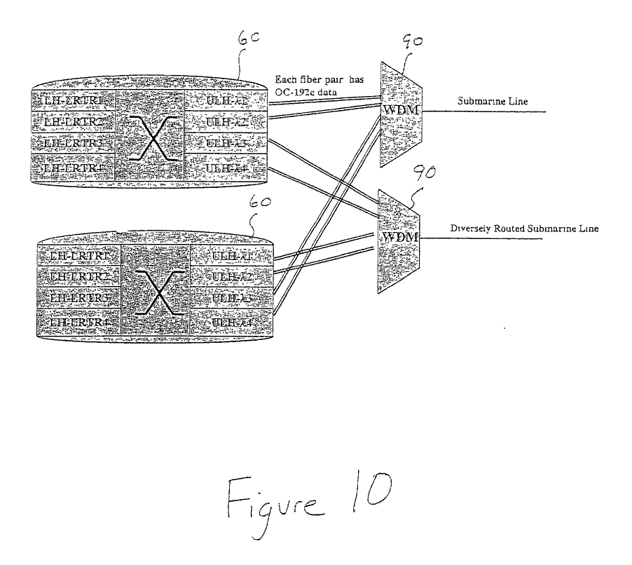

Alternatively, as seen in FIG. 10, each unit 60 may transmit over the complete set of wavelengths available in the system. In this case, connections between the integrated IP routers/LRTRs 60 are arranged so that each unit 60 contributes different subsets of wavelength channels to the input of each WDM unit 90 so that, once again, a complete set of wavelength channels are presented to each WDM unit 90 for combination and transmission over the submarine link.

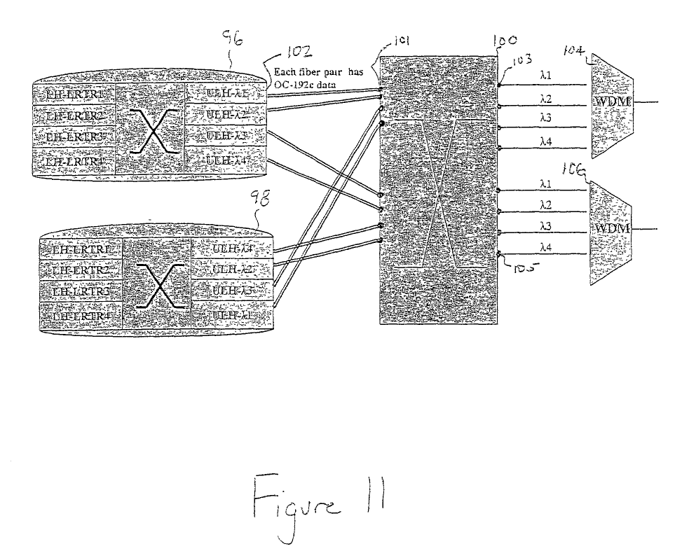

Yet another alternative is seen in FIG. 11 for networks wherein the integrated IP router/LRTRs 96 and 98 have variable wavelength channel assignments. Variable wavelength channel assignments provide the ability, for example, to permit reassignment of channels during the restoration process associated with repairing fiber cuts. The wavelength associated with each LRTR can be made variable either by providing a tunable laser in each LRTR or by providing a wavelength converter within each LRTR or at each input port of an all-optical, optical cross-connect 100. The all-optical, optical cross-connect 100 is placed between the integrated IP router/LRTRs 60 and the WDM units 90 to control the routing of various wavelengths to each WDM equipment 90. For example, suppose that processing branch 102, which is currently assigned channel λ1, is connected to input port 101 of optical cross-connect 100 and output on port 103 to WDM equipment 104. Then, the wavelength assigned to processing branch 102 is switched to channel λ4. At that time, optical cross-connect 100 will reroute the input provided on port 101 to an output port associated with a WDM unit that needs a X4 input, e.g., port 105 to WDM unit 106. In this way, the wavelength balance at the input of each WDM unit is preserved while, at the same time, providing dynamic wavelength switching at each processing branch of integrated IP router/LRTRs. In the receive signal processing branches, a wideband or tunable, narrowband filter should be provided so as to permit passage of any of the available wavelength channels. If a tunable, narrowband filter is used, then changes of wavelength can be communicated to the appropriate receiver via an IP data packet, whereupon the tunable filter can be tuned to accept the new wavelength.

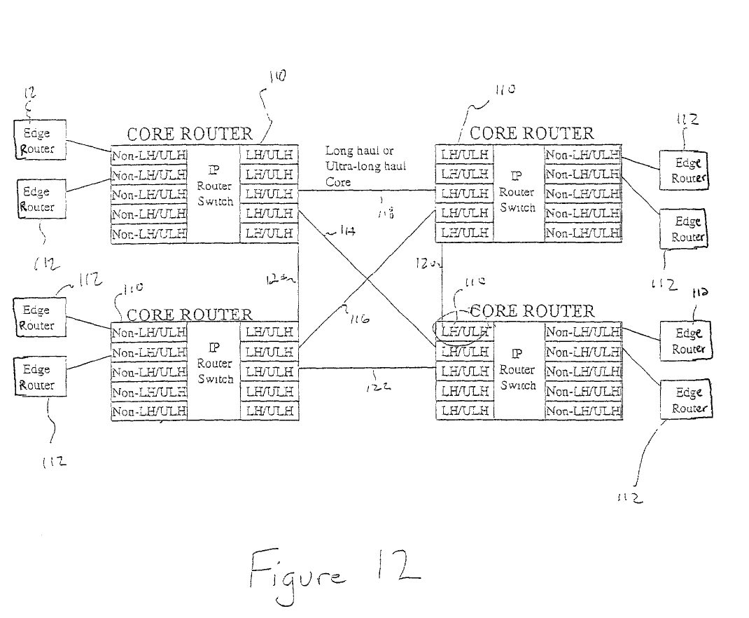

Integrated IP router/LRTRs according to the present invention can also be implemented in a hybrid fashion as depicted in FIG. 12. Therein, core devices 110 include LRTRs 36 integrated with routers (as discussed above) for core connections but also have conventional transponders (e.g., short reach or very short reach interfaces referred to in FIG. 12 as “non-LH/ULH”) for connections to edge devices 112. These short reach/very short reach interfaces provide for optical data communication over less than 100 km and include transmitters that, typically, operate without at least some of FEC, preemphasis, dispersion compensation and modulation chirp which can be found in long reach transceivers. Moreover, these short reach/very short reach interfaces also typically employ non return-to-zero (NRZ) modulation rather than RZ or CSRZ if an external modulation is used at all. Some short reach/very short reach transceivers employ direct modulation, e.g., by varying the laser bias current to modulate the date thereon, rather than connecting the lasers optical output to an external modulator, e.g., a Mach-Zehner type modulator.

The provision of hybrid routers according to the present invention enables architectures in which the network core is formed of devices that are (geographically) widely spaced apart, while supporting a potentially large number of closely spaced edge devices in an economical manner. Note that some of the connections between core routers 110 according to this exemplary embodiment of the present invention can be logical connections, e.g., links 114 and 116, while others can be physical optical fiber links, e.g., 118, 120, 122 and 124. The physical long haul/ultra long haul links 118-122 can be supported using Raman or EDFA amplification techniques as described above. This architecture enables, for example, a core router 110 to receive IP data packets over link 118 and route them through a switching matrix to either an edge device 112 via an SRTR or another core router 112 via an LRTR, all without requiring SONET or SDH framing.

The preferred embodiments have been set forth herein for the purpose of illustration. However, this description should not be deemed to be a limitation on the scope of the invention. Accordingly, various modifications, adaptations, and alternatives may occur to one skilled in the art without departing from the scope of the claimed inventive concept.

1. An integrated internet protocol (IP) router and long reach optical transceiver (LRTR) comprising:
a router switch buffer for receiving incoming IP data packets from a first transceiver;
a router switch for receiving said IP data packets from said router switch buffer and forwarding said IP data packets to a transmit buffer;
a processor for controlling output of said IP data packets in a data stream from said transmit buffer into a long reach transmit processing branch of a second transceiver, wherein said long reach transmit processing branch includes:
a forward error correction (FEC) unit for adding error correction to said data stream to generate a composite data stream; and
a modulator for optically modulating said composite data stream onto a wavelength channel.

2. The integrated internet protocol (IP) router and long reach optical transceiver (LRTR) of claim 1 further comprising:
an IP router clock for clocking said router switch buffer and said router switch; and
an FEC clock for clocking said FEC unit and said processor, wherein said IP router clock and said FEC clock have different clock rates.

3. The integrated internet protocol (IP) router and long reach optical transceiver (LRTR) of claim 1 wherein said processor stuffs overflow from said transmit buffer into overhead fields of a frame structure associated with said FEC unit.

4. The integrated internet protocol (IP) router and long reach optical transceiver (LRTR) of claim 1 wherein said processor provides dummy data to said FEC unit when said transmit buffer experiences an underflow condition.

5. The integrated internet protocol (IP) router and long reach optical transceiver (LRTR) of claim 1, wherein said IP data packets are split into fixed size cells prior to reception by said router switch buffer.

6. The integrated internet protocol (IP) router and long reach optical transceiver (LRTR) of claim 1, wherein said long reach transmit processing branch further comprises:
a fixed wavelength laser, connected to said modulator, for generating optical energy at said wavelength channel.

7. The integrated internet protocol (IP) router and long reach optical transceiver (LRTR) of claim 1, wherein said long reach transmit processing branch further comprises:
a tunable wavelength laser, connected to said modulator, for generating optical energy at said wavelength channel.

8. The integrated internet protocol (IP) router and long reach optical transceiver (LRTR) of claim 1, wherein said modulator modulates said composite data stream onto said wavelength channel using one of return-to-zero (RZ) modulation and carrier suppressed return-to-zero (CSRZ) modulation.

9. The integrated internet protocol (IP) router and long reach optical transceiver (LRTR) of claim 1, wherein said long reach transmit processing branch further comprises:
a demultiplexer for dividing said data stream into a plurality of lower rate data streams, wherein said FEC unit adds said error correction data to each of said plurality of lower rate data streams and outputs a plurality of lower rate error coded data streams; and
a multiplexer for combining said plurality of lower rate error coded data streams into said composite data stream and providing said composite data stream to said modulator.

10. The integrated internet protocol (IP) router and long reach optical transceiver (LRTR) of claim 1, wherein a preemphasis is applied to said composite data signal.

11. The integrated internet protocol (IP) router and long reach optical transceiver (LRTR) of claim 10, wherein said preemphasis is applied to minimize gain excursion.

12. The integrated internet protocol (IP) router and long reach optical transceiver (LRTR) of claim 10, wherein said preemphasis is applied to minimize signal-to-noise ratio (SNR) excursion.

13. The integrated internet protocol (IP) router and long reach optical transceiver (LRTR) of claim 10, wherein said preemphasis is applied to by one of a variable attenuator and a filter.

14. The integrated internet protocol (IP) router and long reach optical transceiver (LRTR) of claim 1, further comprising:
an incoming packet processor for receiving said IP data packets and forwarding said IP data packets to said router switch buffer based on routing information;
at least one memory table for storing said routing information; and
a router processor for updating said at least one memory table.

15. An integrated internet protocol (IP) router and long reach optical transceiver (LRTR) comprising:
a long reach receive processing branch of a first transceiver for receiving a composite, optical data stream on a wavelength channel including:
a demodulator for optically demodulating said composite, optical data stream; and
a forward error correction (FEC) unit for removing error correction data from said demodulated, composite, optical data stream to generate a decoded data stream;
an incoming packet processor for receiving said decoded data stream, extracting IP data packets therefrom and forwarding said IP data packets to a router switch buffer based on routing information; and
a router switch for receiving said IP data packets from said router switch buffer and forwarding said IP data packets to a transmit buffer for transmission via a second transceiver.

16. The integrated internet protocol (IP) router and long reach optical transceiver (LRTR) of claim 15 further comprising:
an IP router clock for clocking said router switch buffer and said router switch; and
an FEC clock for clocking said FEC unit and said processor, wherein said IP router clock and said FEC clock have different clock rates.

17. The integrated internet protocol (IP) router and long reach optical transceiver (LRTR) of claim 15 wherein said incoming packet processor also extracts IP data packets from overhead fields of a frame structure associated with said FEC unit.

18. The integrated internet protocol (IP) router and long reach optical transceiver (LRTR) of claim 15 wherein said incoming packet processor removes dummy data from said decoded data stream.

19. The integrated internet protocol (IP) router and long reach optical transceiver (LRTR) of claim 15, wherein said incoming packet processor combines fixed size cells into said IP data packets.

20. The integrated internet protocol (IP) router and long reach optical transceiver (LRTR) of claim 15, wherein said long reach receive processing branch further comprises:
a wideband or tunable filter, for passing optical energy at said wavelength channel.

21. The integrated internet protocol (IP) router and long reach optical transceiver (LRTR) of claim 15, wherein said demodulator demodulates said composite data stream which has one of a return-to-zero (RZ) modulation and a carrier suppressed return-to-zero (CSRZ) modulation impressed thereon.

22. The integrated internet protocol (IP) router and long reach optical transceiver (LRTR) of claim 15, wherein said long reach receive processing branch further comprises:
a demultiplexer for dividing said demodulated, composite, optical data stream into a plurality of lower rate data streams, wherein said FEC unit removes said error correction data from each of said plurality of lower rate data streams and outputs a plurality of lower rate error decoded data streams; and
a multiplexer for combining said plurality of lower rate error decoded data streams into said composite data stream and providing said decoded data stream to said incoming packet processor.

23. The integrated internet protocol (IP) router and long reach optical transceiver (LRTR) of claim 15, further comprising:
at least one memory table for storing routing information; and
a router processor for updating said at least one memory table, wherein said incoming packet processor requests said routing information from said at least one memory table.

24. The integrated internet protocol (IP) router and long reach optical transceiver (LRTR) of claim 1, wherein said LRTR is adapted to transmit and receive optical signals over distances of greater than 100 km.

25. The integrated internet protocol (IP) router and long reach optical transceiver (LRTR) of claim 15, wherein said LRTR is adapted to transmit and receive optical signals over distances of greater than 100 km.

26. An integrated internet protocol (IP) router, long reach optical transceiver (LRTR) and short reach transceiver (SRTR) comprising:
a long reach receive processing branch of a first transceiver for receiving a composite, optical data stream on a wavelength channel over distances longer than 100 km including:
a demodulator for optically demodulating said composite, optical data stream; and
a forward error correction (FEC) unit for removing error correction data from said demodulated, composite, optical data stream to generate a decoded data stream;
an incoming packet processor for receiving said decoded data stream, extracting IP data packets therefrom and forwarding said IP data packets to a router switch buffer based on routing information;
a router switch for receiving said IP data packets from said router switch buffer and forwarding said IP data packets to a transmit buffer; and
a short reach transceiver for receiving said IP data packets from said transmit buffer and transmitting said IP data packets over distances less than 100 km.

27. The integrated internet protocol (IP) router, LRTR and SRTR of claim 26 further comprising:
an IP router clock for clocking said router switch buffer and said router switch; and
an FEC clock for clocking said FEC unit and said incoming packet processor, wherein said IP router clock and said FEC clock have different clock rates.

28. The integrated internet protocol (IP) router, LRTR and SRTR of claim 26, wherein said incoming packet processor also extracts IP data packets from overhead fields of a frame structure associated with said FEC unit.

29. The integrated internet protocol (IP) router, LRTR and SRTR of claim 26, wherein said incoming packet processor removes dummy data from said decoded data stream.

30. The integrated internet protocol (IP) router, LRTR and SRTR of claim 26, wherein said incoming packet processor combines fixed size cells into said IP data packets.

31. The integrated internet protocol (IP) router, LRTR and SRTR of claim 26, wherein said long reach receive processing branch further comprises:
a wideband or tunable filter, for passing optical energy at said wavelength channel.

32. The integrated internet protocol (IP) router, LRTR and SRTR of claim 26, wherein said demodulator demodulates said composite data stream which has one of a return-to-zero (RZ) modulation and a carrier suppressed return-to-zero (CSRZ) modulation impressed thereon and wherein said SRTR modulates said IP data packets using non return-to-zero (NRZ) modulation.

33. The integrated internet protocol (IP) router, LRTR and SRTR of claim 26, wherein said long reach receive processing branch further comprises:
a demultiplexer for dividing said demodulated, composite, optical data stream into a plurality of lower rate data streams, wherein said FEC unit removes said error correction data from each of said plurality of lower rate data streams and outputs a plurality of lower rate error decoded data streams; and
a multiplexer for combining said plurality of lower rate error decoded data streams into said composite data stream and providing said decoded data stream to said incoming packet processor.

34. The integrated internet protocol (IP) router, LRTR and SRTR of claim 26, further comprising:
at least one memory table for storing routing information; and
a router processor for updating said at least one memory table, wherein said incoming packet processor requests said routing information from said at least one memory table.

35. The integrated internet protocol (IP) router and LRTR of claim 3, wherein said processor adds an indicator to mark said overflow within said overhead fields.

36. The integrated internet protocol (IP) router and LRTR of claim 4, wherein said processor adds an indicator to mark said dummy data within said composite data stream.
